(19) United States
(12) Patent Application Publication
(10) Pub. No.: US 2006/0142675 A1
(43) Pub. Date: Jun. 29, 2006

(54) Apparatus for applying pressure to a head or neck and a method for relief

(76) Inventor: Eric W. Sargent, Birmingham, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/024,090

(22) Filed: Dec. 28, 2004

(51) Int. Cl. A61H 1/00

(52) U.S. Cl. 601/70; 601/134; 601/69; 601/67

(57) ABSTRACT

The present invention discloses an apparatus for applying pressure to a head and/or a neck of a user. The apparatus includes an arcuate substrate for receiving a portion of the head and/or the neck of the user. A node is affixed to the substrate for engaging the user and applying a focalized pressure thereupon. A flexible member is attached to the substrate for securing the apparatus to the user and for applying tension to the substrate for generating the focalized pressure. A method for relief is disclosed for application of a pair of nodes to the suboccipital area of the user.

### BACKGROUND OF THE INVENTION

1. Field of the Invention

The invention relates to an apparatus for applying pressure to a head of a user, more particularly to an apparatus that is secured to the user for applying pressure to the user.

2. Background Art

It is common for people to experience migraine or tension headaches, which are associated with the head and/or neck of the user. These ailments may be relieved upon an application of pressure or massage to particular pressure points on the head or the neck of the user.

Accordingly, the prior art has provided a plurality of headbands for applying pressure or other effects to the head of the user. Such headbands however apply unnecessary pressure to non-target areas of the head. Additionally, many prior art headbands are limited to use with the head of the user only.

Prior art headbands generally engage the user's head about the perimeter. Thus, if a predetermined pressure is desired at focal points, a pressure is applied on one side of the user's head, including focalized pressures and general contact pressures, in combination with a resultant pressure applied on the other side of the user's head.

It is a goal of the present invention to provide an apparatus for applying pressure to the head and/or neck of the user that targets the pressure points of the user and is not limited in the manners of prior art apparatuses.

### SUMMARY OF THE INVENTION

An aspect of the present invention is to provide an apparatus for applying pressure to a head and/or neck of a user. The apparatus comprises a first member sized to receive a portion of the head or the neck for imparting a focalized pressure thereupon. A second member is operably connected to the first member for securing the apparatus to the user.

Another aspect of the present invention is to provide an apparatus having a semi-rigid arcuate substrate for receiving a portion of the head or the neck of the user therein. At least one node is affixed to the substrate for applying a focalized pressure to the user. A flexible member is attached to the substrate for securing the apparatus to the user and for applying tension to the substrate, thus applying the focalized pressure to the at least one node.

A further aspect of the present invention is to provide an apparatus for applying pressure to a suboccipital area of the user.

Yet another aspect of the present invention is a method for relief by applying pressure to the suboccipital area of the user by a pair of nodes that are urged by a flexible member in tension.

The above aspects and other aspects, objects, features, and advantages of the present invention are readily apparent from the following detailed description of the embodiments of the present invention when taken in connection with the accompanying drawings.

### BRIEF DESCRIPTION OF THE DRAWINGS

FIG. 1 is a side elevation view of an apparatus for applying pressure to a head or a neck of a user in accordance with the teachings of the present invention, illustrated secured to a user;

FIG. 2 is a top plan view of the apparatus of FIG. 1;

FIG. 3 is a top plan schematic diagram illustrating the pressure applied upon the user;

FIG. 4 is a front elevation view of the apparatus of FIG. 1, illustrated in a partially flattened manner;

FIG. 5 is a side partial section view of a node of the apparatus of FIG. 1; and

FIG. 6 is a front elevation view of a cooling apparatus in accordance with the teachings of the present invention.

### DETAILED DESCRIPTION OF EMBODIMENTS OF THE INVENTION

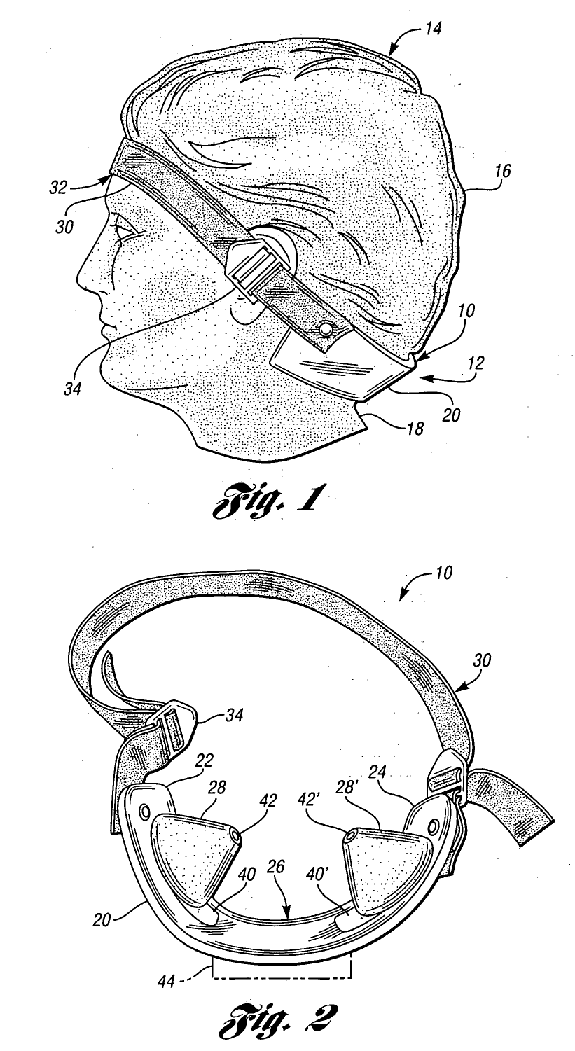

With reference to FIG. 1, an apparatus for applying pressure to a head or a neck of a user is illustrated and referenced generally by numeral 10. Tension, migraines and headaches may be relieved by applying a pressure to a suboccipital area 12 of a user 14. The suboccipital area 12 is the area wherein the head 16 and neck 18 of the user 14 intersect.

Referring to FIGS. 1 and 2, the pressure-applying apparatus 10 includes a substrate 20. The substrate 20 is generally arcuate and has a first end 22 and a second end 24, with an intermediate region 26 disposed therebetween. The substrate 20 is curved to receive a portion of the head 16 or the neck 18 of the user 14 partially therein. The pressure-applying apparatus 10 includes a pair of nodes 28, 28′ mounted to the substrate intermediate region 26. The nodes 28, 28′ are positioned upon the substrate 20 for applying focalized pressures upon the suboccipital area 12 of the user 14.

The apparatus 10 includes, for example, an adjustable fabric strap 30 connected to the substrate first end 22 and the substrate second end 24 for securing the apparatus 10 to the user 14. The strap 30 may be secured about a forehead 32, for example, of the user 14 for securing the pressure-applying apparatus 10 to the user 14 and for applying pressure to the suboccipital area 12. The strap 30 may include buckle 34 for permitting lengthwise adjustment of the strap 30. The adjustability of the strap 30 permits the user 14 to apply tension to the strap 30 and consequently upon the substrate 20 for providing the resultant focalized pressures upon the nodes 28, 28′. The strap 30 may be connected to the substrate first end 22 and second end 24 via pivotal connections for enhancing the flexibility of the strap 30 relative to the substrate 20. The pivotal connections may be a conventional snap.

The substrate 20 may be molded from a semi-rigid polymeric material, such as injection-molded polyethylene. Due to the profile of the substrate 20, and the material utilized, the user is contacted by the nodes 28, 28′ at the target area and the strap 30 at the forehead 32. The substrate 20 avoids direct contact upon the user at the suboccipital area 12 such that the focalized pressures are the only pressures applied in this region.

Unlike the prior art, the pressure applied to the target area is substantially limited to focalized pressures. Therefore, the pressure applied at the forehead 32 is substantially a result of the focalized pressures only. In comparison with the prior art, the apparatus 10 of the present invention applies less pressure overall about the perimeter of the head 16 and the neck 18 of the user 14 by minimizing pressures to non-target areas adjacent to the target areas.

A pressure distribution is illustrated in FIG. 3, which is a schematic of the pressures imparted upon the user by the pressure-applying apparatus 10, when viewed from the top plan view. The user experiences focalized pressures 36, 36′ at the node contact regions of the suboccipital area 12. The user also experiences a resultant pressure applied upon the surface of the forehead 32 wherein the strap engages; such pressure is commonly referred to as a hoop stress, or in this instance a partial hoop stress 38. The partial hoop stress 38 is a resultant pressure of the opposed pressure applied upon the user at the contact points 36, 36′.

Prior art headbands commonly apply a partial hoop stress adjacent to the focalized pressures 36, 36′ as well. With utilization of a prior art headband, a greater partial hoop stress 38 is required to counteract the focalized pressures 36, 36′ and extraneous partial hoop stresses. Therefore, by providing the pressure-applying apparatus 10 of the present invention, which, for example, utilizes the substrate 20 that avoids direct contact with the user at the target area, less overall pressure is applied to the user's head 14 than that which is required in prior art apparatuses. Due to the rigidity of the substrate 20, the user may be received at least partially within the substrate 20 without substantially engaging the substrate 20. This relationship is illustrate in FIG. 3 wherein the suboccipital area 12 intersects a chord between the ends of the substrate 20.

Referring again to FIGS. 1 and 2, the pressure-applying apparatus 10 of the present invention overcomes shortcomings of the prior art by providing an apparatus that is affixable to the suboccipital area 12 of the user 14. Many prior art headbands are ineffective for applying pressure to this area because the ears of the user 14 interfere with the headband and, the headbands tend to ride up along the head 16 thereby terminating contact with the suboccipital area 12. The apparatus 10 of the present invention however, utilizes the substrate 20, which is contoured to the nape of the user's neck 18 to maintain a relative positioning thereto.

The present invention contemplates that various substrates 20 may be provided for cooperation with necks of varying size. Additionally, the substrate 20 may be fabricated to predetermined dimensions corresponding to a particular user. For example, a mold may be generated from the user's neck. Then, the substrate may be heated to a temperature that renders the material pliable, (such as three hundred degrees Fahrenheit for a substrate formed from a polyethylene sheet). Subsequently, the substrate can be molded upon the replica of the user's neck to result in a customized pressure-applying apparatus 10 for the particular user.

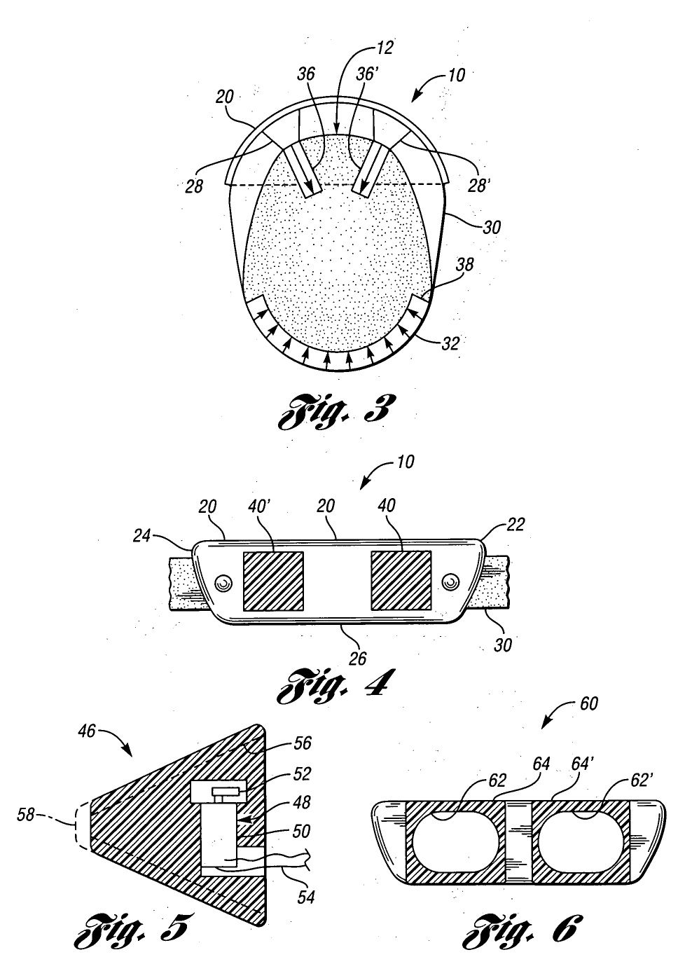

With reference now to FIG. 4, the substrate 20 of the pressure-applying apparatus 10 is illustrated flattened for clarity with the nodes 28, 28′ removed. The substrate 20 includes a pair of adjustable fasteners formed thereon for receiving the nodes 28, 28′. For example, a pair of pads 40, 40′ are illustrated that are formed from a hook and loop material. Corresponding hook and loop fastener pads (not shown) are applied to the undersides of the nodes 28, 28′ for permitting the adjustable attachment of the nodes 28, 28′ to the substrate 20. Although hook and loop fasteners are illustrated, any adjustable fastener is contemplated within the spirit and scope of the present invention.

The prior art apparatuses are provided with fixed nodes, thus limiting the applicability of a common design to adequately apply pressure to various users. The adjustability of the pressure-applying apparatus 10 permits the user 14 to adjust the positioning of the nodes 28, 28′ to engage desired pressure points upon the head 16 or the neck 18 of the user 14. Thus, various users may receive adequate pressure from a common apparatus that incorporates adjustability.

The adjustability of the nodes 28, 28′ permits interchangeability of the nodes 28, 28′ with other nodes varying in shape or durometer. For example, frusto-conical nodes 28, 28′ are illustrated, however various node shapes are contemplated, such as hemispherical nodes, or the like. Additionally, nodes molded of various durometers permit the user to select the relative rigidity or flexibility of the nodes 28, 28′ applied upon the focalized pressure points.

Referring again to FIG. 2, the nodes 28, 28′ may each include an electrode 42, 42′ oriented thereon for imparting transcutaneous electrical nerve stimulation to the pressure points of the user. A power supply 44, which is illustrated in phantom in FIG. 2, may be secured to the pressure-applying apparatus 10 and wired to the electrodes 42, 42′ for imparting the current to electrodes 42, 42′. The power supply 44 may regulate the amplitude and frequency of the current upon the electrodes 42, 42′ so that a continuous or pulsed stimulation is applied to the user 14. Electrical nerve stimulation is known in the art for modifying or reducing ailments upon a user, such as soreness, tension or the like.

With reference now to FIG. 5, an alternative node 46 is illustrated in accordance with the teachings of the present invention. The node 46 may be utilized with the pressure-applying apparatus 10, and may be adjustably affixed to the substrate 20. The node 46 includes a vibratory massager 48 therein for imparting a vibratory massage effect from the node 46 to the target area of the user 14. The vibratory massager 48 includes a motor 50 secured within the node 46. The motor 50 drives an eccentric weight 52 such that rotation of the weight 52 vibrates the node 46 and an associated pressure point on the user 14. Wires 54 pass through the node 46 and are powered by the power supply 44 on the apparatus 10.

In the alternative, the node 46 may include a cavity 56 formed therein, which is illustrated in phantom in FIG. 5. An ice pack or similar cooling apparatus may be retained within the cavity 56 for imparting a cooling effect upon the contact portion of the user 14. Additionally, a conductive contact pad 58 may be provided on the tip of the node 46 for an increased heat transfer through the conductive pad 58 in relation to the limited rate of heat transfer through the generally non-conductive elastomeric material of the node 46. Thus, the node 46 may provide a cooling effect to soothe and relax the user as the focalized pressure is applied thereon.

Alternatively, or in addition to the cooling system depicted in FIG. 5, a separate ice pack or similar cooling apparatus may be affixed to the inner surface of the substrate 20 to provide generalized cooling to the neck 18, head 16, or suboccipital area 12. Referring to FIG. 6, an alternative cooling apparatus 60 is provided. The cooling apparatus 60 may include apertures 62, 62′ formed therethrough for permitting clearance for the massage nodes 28, 28′. The cooling apparatus 60 may also include one of a hook and loop fastener 64, 64′ for selective attachment to the hook and loop fasteners 40, 40′ of the substrate 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for applying pressure to a suboccipital area of a user comprising:
a semi-rigid arcuate substrate sized to receive a portion of the suboccipital area of the user at least partially therein;
at least one node affixed to the substrate for engaging the portion of the suboccipital area of the user for applying a focalized pressure thereto; and
a flexible member attached to the substrate for securing the apparatus to the head or neck of the user and for applying tension to the substrate thereby providing the focalized pressure of the at least one node.

2. The pressure-applying apparatus of claim 1 wherein the at least one node is further defined as a pair of spaced apart nodes.

3. The pressure-applying apparatus of claim 1 wherein the at least one node is adjustable relative to the substrate.

4. The pressure-applying apparatus of claim 1 wherein the apparatus applies a partial hoop stress, as a result of the focalized pressure caused by the at least one node, to the head or neck of the user at an orientation that is spaced apart and opposed from the at least one node.

5. The pressure-applying apparatus of claim 1 wherein the flexible member is further defined as an adjustable fabric strap.

6. The pressure-applying apparatus of claim 1 wherein the substrate is formed from a molding operation.

7. The pressure-applying apparatus of claim 1 wherein the substrate is molded to predetermined dimensions corresponding to a particular user's head or neck.

8. The pressure-applying apparatus of claim 1 wherein the substrate is formed from a polymeric material.

9. The pressure-applying apparatus of claim 1 wherein the substrate is formed from polyethylene.

10. The pressure-applying apparatus of claim 1 wherein the at least one node is formed from an elastomeric material.

11. The pressure-applying apparatus of claim 1 wherein the at least one node is interchangeable with nodes of varying durometers.

12. The pressure-applying apparatus of claim 1 wherein the at least one node further comprises an electrode for imparting electrical current to the user for providing electrical nerve stimulation.

13. The pressure-applying apparatus of claim 1 wherein the at least one node further comprises a motorized massager for imparting a massage effect to the user.

14. The pressure-applying apparatus of claim 1 wherein the pressure-applying apparatus further comprises a cooling system for applying a cooling effect to the user.

15. The pressure-applying apparatus of claim 1 wherein the flexible member engages a forehead of the user.

16. The pressure-applying apparatus of claim 1 wherein the at least one node is further defined as a pressure formation having spaced apart contact regions for engaging spaced apart pressure points in the suboccipital area for relieving tension, stress or headaches.

17. An apparatus for applying pressure to a head or a neck of a user comprising:
a semi-rigid arcuate substrate sized to receive a portion of the head or the neck of the user at least partially therein such that the portion of the head or neck of the user intersects a chord between a first end and a second end of the substrate;
at least one node affixed to the substrate for engaging the portion of the head or the neck of the user for applying a focalized pressure thereto; and
a flexible member attached to the substrate for securing the apparatus to the head or neck of the user and for applying tension to the substrate thereby providing the focalized of the at least one node.

18. The pressure-applying apparatus of claim 17 wherein the at least one node engages a nape of the user's neck.

19. The pressure-applying apparatus of claim 17 wherein the at least one node engages a suboccipital area of the user.

20. A method for treating migraine or tension headaches comprising:
providing an apparatus having a pair of nodes selectively aligned with pressure points of a user's suboccipital area;
affixing a flexible member to the head of the user for maintaining engagement of the nodes with the user's suboccipital area; and
tensioning the flexible member for applying a focalized pressure from the nodes to the pressure points.
